(19) United States
(12) Patent Application Publication
(10) Pub. No.: US 2026/0229995 A1
(43) Pub. Date: Aug. 6, 2026

(54) DC-DC CONVERTERS HAVING REFERENCE VOLTAGE PREDISTORTION FOR OPTIMAL DYNAMIC VOLTAGE SCALING RESPONSE

(71) Applicant: Empower Semiconductor, Inc., Milpitas, CA (US)

(72) Inventor: Gabriel EIREA, Mountain View, CA (US)

(73) Assignee: Empower Semiconductor, Inc., Milpitas, CA (US)

(21) Appl. No.: 19/423,400

(22) Filed: Dec. 17, 2025

Related U.S. Application Data
(60) Provisional application No. 63/753,860, filed on Feb. 4, 2025.

(51) Int. Cl. H02M 3/158

(52) U.S. Cl. CPC H02M 3/158

(57) ABSTRACT

A DC-DC converter is disclosed. The DC-DC converter includes a first switch coupled to a second switch at a switch node, the first switch coupled to an input terminal and the second switch coupled to ground, and the switch node coupled to an output terminal, a control circuit arranged to generate an output voltage at the output terminal via the first and second switches, the control circuit comprising a reference voltage generation circuit arranged to generate a pre-distorted reference signal in response to a command specifying a target output voltage and a desired ramp, the desired ramp having a desired ramp rate and a desired transition time. In one aspect, the pre-distorted reference signal comprises a compensation component that compensates for dynamic response characteristics of the DC-DC converter such that the control circuit regulates the output voltage to track the target output voltage and desired ramp rate.

### CROSS REFERENCE TO RELATED APPLICATIONS

This application claims priority to U.S. provisional patent application No. 63/753,860, for “DC-DC CONVERTERS HAVING REFERENCE VOLTAGE PREDISTORTION FOR OPTIMAL DYNAMIC VOLTAGE SCALING RESPONSE” filed on Feb. 4, 2025, which is hereby incorporated by reference in entirety for all purposes.

### FIELD

The described embodiments relate generally to power converters, and more particularly, the present embodiments relate to DC-DC converters having reference voltage predistortion for optimal dynamic voltage scaling (DVS) response.

### BACKGROUND

A wide variety of electronic devices are available for consumers today. Many of these devices have integrated circuits that are powered by regulated low voltage DC power sources. These low voltage power sources are often generated by dedicated power converter circuits that use a higher voltage input from a battery or another power source. In some applications, the dedicated power converter circuit can be one of the largest power dissipating components of the electronic device and can sometimes consume more space than the integrated circuit that it powers. As electronic devices become more sophisticated and more compact, more efficient power converter circuits are called for.

### SUMMARY

In some embodiments, a DC-DC converter is disclosed. The DC-DC converter includes a first switch coupled to a second switch at a switch node, the first switch coupled to an input terminal and the second switch coupled to ground, and the switch node coupled to an output terminal; a control circuit coupled to the first and second switches, and arranged to generate an output voltage at the output terminal via the first and second switches, the control circuit including a reference voltage generation circuit arranged to generate a pre-distorted reference signal in response to a command specifying a target output voltage and a desired ramp, the desired ramp having a desired ramp rate and a desired transition time, where the pre-distorted reference signal includes a compensation component that compensates for dynamic response characteristics of the DC-DC converter such that the control circuit regulates the output voltage to track the target output voltage and desired ramp rate.

In some embodiments, the pre-distorted reference signal is calculated based on the desired ramp rate plus an exponential decay term.

In some embodiments, the exponential decay term comprises an amplitude factor and a time constant, wherein the time constant is based on a closed-loop transfer function of the DC-DC converter.

In some embodiments, the closed-loop transfer function is based on an inner current loop transfer function, a compensator transfer function, and an output impedance transfer function of the DC-DC converter.

In some embodiments, the reference voltage generation circuit comprises a lookup table having precomputed exponential values, and wherein the reference voltage generation circuit is arranged to retrieve exponential values from the lookup table during generation of the pre-distorted reference signal.

In some embodiments, the reference voltage generation circuit comprises a digital filter arranged to generate the exponential decay term by filtering the desired ramp rate.

In some embodiments, the reference voltage generation circuit is arranged to generate the pre-distorted reference signal as a piecewise linear approximation comprising a plurality of linear segments with different slopes.

In some embodiments, the plurality of linear segments includes: a first segment having a first slope during a first time interval; a second segment having a second slope during a second time interval following the first time interval; and a third segment having a third slope during a third time interval following the second time interval, wherein the first slope is greater than a slope of the desired ramp rate.

In some embodiments, the first time interval extends from a start time to a time equal to a transition end time minus one-quarter of a switching period of the DC-DC converter.

In some embodiments, the reference voltage generation circuit comprises a prefilter arranged to filter an input signal to generate the pre-distorted reference signal, wherein the prefilter has a transfer function that is an inverse of a closed-loop transfer function of the DC-DC converter.

In some embodiments, the input signal comprises a ramp signal having a slope equal to the desired ramp rate.

In some embodiments, the input signal comprises a pulse signal having a constant amplitude during a transition period.

In some embodiments, the reference voltage generation circuit is arranged to terminate the pre-distorted reference signal at a time earlier than a nominal end time of the desired ramp by an amount equal to a phase-dependent delay of the DC-DC converter.

In some embodiments, the DC-DC converter comprises a multi-phase converter having N phases, and wherein the phase-dependent delay is equal to a switching period divided by N.

In some embodiments, the reference voltage generation circuit includes: a digital signal processor arranged to compute the pre-distorted reference signal based on stored system parameters; and a digital-to-analog converter coupled to the digital signal processor and arranged to convert the pre-distorted reference signal to an analog voltage signal provided to the control circuit.

In some embodiments, the stored system parameters comprise at least one of: an inner current loop transfer function parameter, a compensator transfer function parameter, an output impedance transfer function parameter, a switching period, an on-time duration, a number of phases, an input voltage, and an inductance value.

In some embodiments, the control circuit comprises a comparator arranged to compare the output voltage of the DC-DC converter with the pre-distorted reference signal to generate an error signal; and a compensator arranged to process the error signal to generate a control signal for controlling switching of the DC-DC converter.

In some embodiments, the reference voltage generation circuit is arranged to adapt parameters of the pre-distorted reference voltage signal based on measured performance of voltage transitions.

In some embodiments, a method of operating a DC-DC converter is disclosed. The method includes: providing a first switch coupled to a second switch at a switch node, the first switch coupled to an input terminal and the second switch coupled to ground, and the switch node coupled to an output terminal; receiving a command specifying a target output voltage and a desired ramp, the desired ramp having a desired ramp rate and a desired transition time; generating a pre-distorted reference signal in response to the command, where the pre-distorted reference signal includes a compensation component that compensates for dynamic response characteristics of the DC-DC converter; and regulating an output voltage at the output terminal via the first and second switches based on the pre-distorted reference signal such that the output voltage tracks the target output voltage and desired ramp rate.

In some embodiments, a circuit is disclosed. The circuit includes a first switch coupled to a second switch at a switch node, the first switch coupled to an input terminal and the second switch coupled to ground, and the switch node coupled to an output terminal; a control circuit coupled to the first and second switches, and arranged to generate an output voltage at the output terminal via the first and second switches, the control circuit having a reference voltage generation circuit arranged to generate a pre-distorted reference signal in response to a command specifying a target output voltage and a desired ramp, the desired ramp having a desired ramp rate and a desired transition time, where the pre-distorted reference signal is calculated based on the desired ramp rate plus an exponential decay term, the exponential decay term including an amplitude factor and a time constant, such that the control circuit regulates the output voltage to track the target output voltage and desired ramp rate.

### BRIEF DESCRIPTION OF THE DRAWINGS

FIG. 1 illustrates a DC-DC converter circuit having reference voltage predistortion for optimal dynamic voltage scaling (DVS) response, according to certain embodiments;

FIG. 2 illustrates a block diagram of the voltage regulation loop of the power converter of the FIG. 1, according to certain embodiments;

FIG. 3 illustrates an exemplary ramp during a DVS starting at zero, having a slope Sr and ending at time tr;

FIG. 4 illustrates a comparison of a generated reference voltage with the original ramp for a set of typical application values, according to some embodiments;

FIG. 5 graphically illustrates equations (1) and (2) for generating a pre-distorted reference voltage;

FIGS. 6A and 6B show a comparison of output voltages generated by current approaches (6A) and by methods disclosed herein (6B);

FIG. 7 illustrates a graph showing a linear approximation for the generated reference voltage in response to a ramp signal, according to some embodiments; and

FIG. 8 illustrates the converter response with new pre-distorted reference signal in response to the ramp signal, according to some embodiments.

### DETAILED DESCRIPTION

Circuits, devices and related techniques disclosed herein relate generally to power converters. More specifically, circuits, devices and related techniques disclosed herein relate to DC-DC converters having reference voltage predistortion for optimal dynamic voltage scaling (DVS) response. Further, circuits and techniques disclosed herein relate to DC-DC converters employing DVS with improved transient response characteristics through reference voltage predistortion techniques. In some embodiments, a reference voltage used in a voltage regulator control loop can be pre-distorted based on dynamics of the voltage regulator, such that the output voltage of the regulator tracks a desired ramp with minimum deviations. In this way, transitions of the output voltage can be improved such that the converter can have relatively less delay and less overshoot as compared to current approaches. Embodiments of the disclosure enable transitions with relatively high speed and high precision with relatively high level of regulation. In this way, better converter performance can be achieved, and less power may be dissipated resulting in economic savings. In various embodiments, when the converter voltage scaling transition is set to a relatively low voltage, undershoot in the output of the regulator can be prevented. In general, undershoot is to be prevented because presence of an undershoot in a voltage regulator may generate a fault condition in a processor being supplied by the regulator. Embodiments of the disclosure can enable relatively tight control of the output voltage transitions, thus increasing reliability of operation of the voltage regulator.

Modern processors and integrated circuits employ Dynamic Voltage Scaling to balance computational performance against power consumption. During periods of high computational load, a processor may request a higher supply voltage from a voltage regulator to enable increased operating frequency without timing violations. During periods of low computational load, the processor may request a lower supply voltage to reduce power consumption through both reduced operating frequency and decreased leakage current. Embodiments of the disclosure enable control of these voltage transitions with speed and precision resulting in improved overall system performance and reduced power dissipation.

When a voltage regulator receives a command to change the output voltage, conventional approaches apply a simple ramp reference voltage to the converter control loop. However, the inherent dynamics of the converter, including delays in current control loops, output impedance characteristics, and comparator response, may cause the actual output voltage to deviate from the desired ramp trajectory. This deviation may manifest as delayed response to voltage change requests, overshoot when transitioning to higher voltages, and undershoot when transitioning to lower voltages. The undershoot during transitions to lower voltages may be particularly problematic, as the supply voltage may fall below minimum acceptable levels, potentially causing processor faults and unreliable operation. Circuits and techniques disclosed herein can address these challenges by introducing predistortion to the reference voltage signal that anticipates and compensates for the converter's dynamic response. Various inventive embodiments are described herein, including methods, processes, systems, devices, and the like.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

In current approaches, the dynamics of operation of DC-DC regulator may create a response during transitions that is characterized by a delay and by an overshoot/undershoot. The delay and overshoot/undershoot may prevent normal operation of the regulator and may even get worse as the ramp rate increases. DVS can allow the controller to change the converter output voltage as needed. A tradeoff between power consumption and computing performance may be managed by DVS techniques. During periods of large computational load, the processor can request the voltage regulator to supply a relatively large supply voltage in order to increase the operating frequency without operational timing violations. During periods of low computational load, the processor may request a relatively low supply voltage in order to reduce the power consumption.

Embodiments of the disclosure can provide an output voltage during a transition that can have a selectable ramp-rate that can start at a pre-transition reference voltage and may end at a post-transition reference voltage. Circuits and methods described herein enable making DVS transitions relatively accurate with relatively less delay and less overshoot/undershoot. In some embodiments, disclosed methods can be implemented by:
1. Direct digital waveform generation
2. Addition of an exponential term to the ramp:
   a. The exponential is precomputed.
   b. The exponential is directly computed on the fly.
   c. The exponential is generated by a digital filter.
3. Piecewise linear approximation of the waveform
4. Prefiltering the ramp signal
5. Prefiltering the pulse signal

These techniques are described in more detail below.

In some embodiments, a reference voltage predistortion method for optimal DVS can be based on assumptions that: 1) The dc-dc converter having an inner current control loop that is relatively fast to be considered a voltage-controlled current source; and 2) The voltage loop compensator is a proportional-integral (PI) controller. These assumptions can work for a wide range of DC-DC converters. It shall be understood that alternate methods and models of a power converter can be included in the analysis and are within the scope of this disclosure, and a person skilled in the art can follow a similar procedure to derive the reference voltage predistortion method for in each particular case.

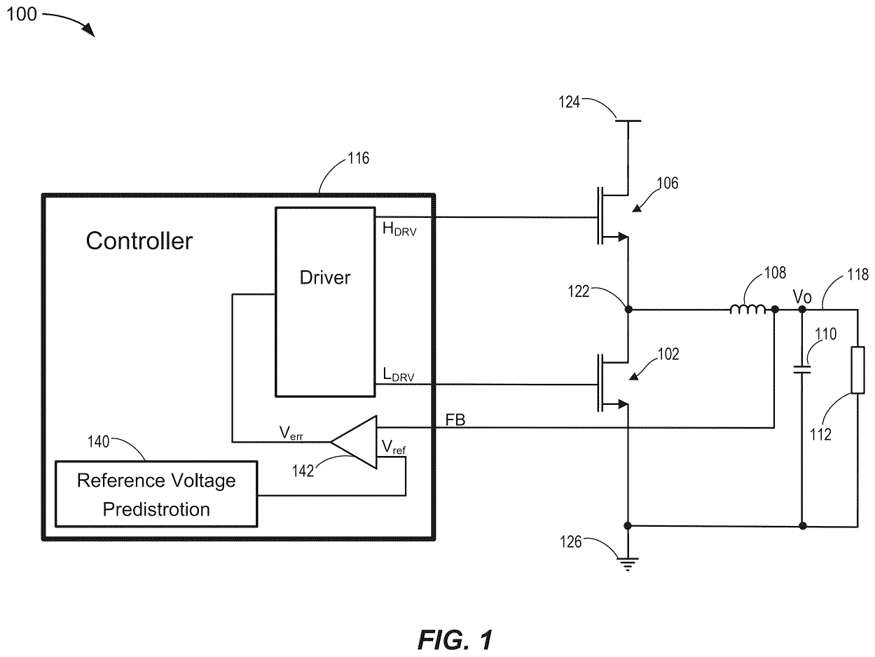

FIG. 1 illustrates a DC-DC converter circuit having reference voltage predistortion for optimal dynamic voltage scaling (DVS) response, according to certain embodiments. In the illustrated embodiment, circuit 100 can include a switch 102 coupled to a switch 106 at a switch node 122, an inductor 108 coupled to the switch node, and a controller circuit 116 coupled to switches 102 and 106. The inductor 108 can be coupled to an output capacitor 110 and to a load 112 at an output terminal 118. The switch 106 can be coupled to an input voltage at input terminal 124 and the switch 102 can be couped to a ground 126. In some embodiments, the switches 102 and 106 may be transistors. In various embodiments, the transistors may be field effect transistors (FET). In some embodiments, the transistors may be metal-oxide-semiconductor field effect transistors (MOSFETS).

Circuit 100 can be arranged to receive an input voltage at input terminal 124 and generate an output voltage Vo at the output terminal 118. The controller circuit 116 may be arranged to control conductivity states of the switches 102 and 106. The controller circuit 116 may further be arranged to receive a feedback signal FB from the output terminal 118. In some embodiments, the controller circuit 116 can include a reference voltage predistortion circuit 140. The reference voltage predistortion circuit 140 can be arranged to generate a reference voltage Vref. An amplifier 142 may be arranged to receive the FB signal and compare it to the Vref and generate an error voltage Verr.

In some embodiments, the reference voltage predistortion circuit 140 can be arranged to generate a pre-distorted reference voltage waveform that compensates for dynamic characteristics of the converter circuit 100. The pre-distorted reference voltage may also be referred to as pre-distorted reference signal. The pre-distorted reference voltage waveform may be arranged to cause the output voltage Vo to follow a desired ramp trajectory during DVS transitions. The reference voltage predistortion circuit 140 can be arranged to modify a reference voltage signal such that delays and resonances inherent in the converter transfer function may be compensated. In various embodiments, the reference voltage predistortion circuit 140 can be implemented using digital signal processing techniques. In certain embodiments, the reference voltage predistortion circuit 140 can be implemented using analog circuitry.

### Transfer Function Analysis and Modeling

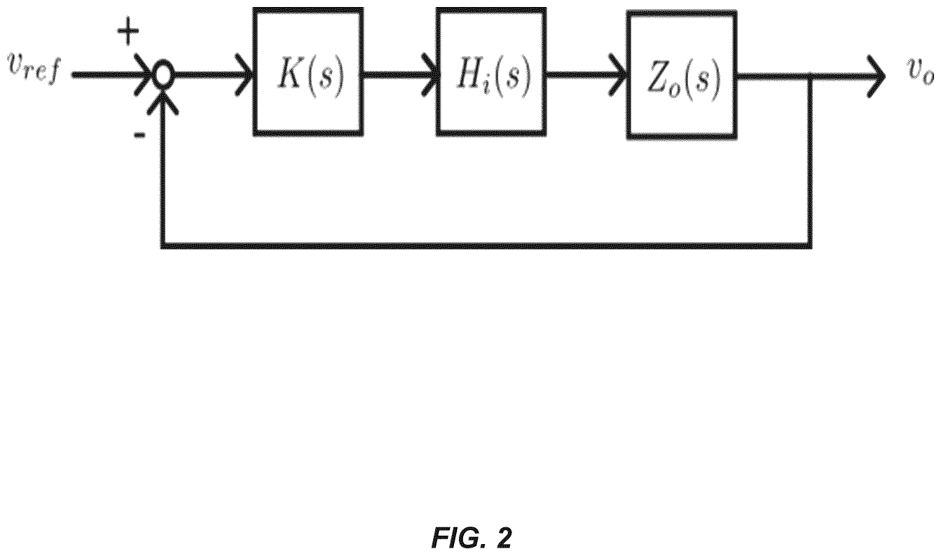

FIG. 2 illustrates a block diagram of a voltage regulation loop of the power converter of FIG. 1, according to certain embodiments. In FIG. 2, a transfer function from a reference voltage to an output voltage in closed loop can be represented. The block diagram can include a PI controller transfer function K(s) that may be arranged to process an error signal. The PI controller transfer function can be expressed in terms of a transconductance gm, a resistance Rc, and a capacitance Cc. An inner current loop transfer function Hi(s) can be arranged to represent a gain of an inner current control loop. The inner current loop transfer function can be expressed in terms of a transconductance gmc. An output impedance transfer function Zo(s) can be arranged to represent an impedance seen by the converter at an output. The output impedance transfer function can be expressed in terms of an output capacitance Co.

In some embodiments, the closed-loop transfer function H(s) from the reference voltage to the output voltage can be characterized by a zero time constant τz and a natural frequency on. The zero time constant τz may be equal to a product of the resistance Rc and the capacitance Cc. The natural frequency squared ωn² may be equal to a product of the transconductance gm and the transconductance gmc divided by a product of the capacitance Cc and the output capacitance Co. In various embodiments, the closed-loop transfer function H(s) can be arranged to exhibit second-order dynamics with a zero. The presence of the zero in the transfer function can cause the output voltage to deviate from a desired ramp trajectory when a simple ramp reference voltage may be applied.

In certain embodiments, the transfer function H(s) can be arranged to introduce delays in the response of the output voltage to changes in the reference voltage. The delays may result from dynamics of the PI controller, the inner current loop, and the output impedance. In some embodiments, the transfer function H(s) can be arranged to cause overshoot when the output voltage may be transitioning to a higher voltage level. In various embodiments, the transfer function H(s) can be arranged to cause undershoot when the output voltage may be transitioning to a lower voltage level. The undershoot during transitions to lower voltages may be particularly problematic because the supply voltage can fall below minimum acceptable levels.

In FIG. 2, the PI controller transfer function can be:

$$K ( s ) = \frac{g m ( {R}_{c} {C}_{c} s + 1 )}{{C}_{c} s}$$

The gain of the inner current loop can be written as:

$${H}_{i} ( s ) = {g}_{m c}$$

The output impedance seen by the converter can be written as:

$${Z}_{o} ( s ) = \frac{1}{{C}_{o} s}$$

Thus, a transfer function from the reference voltage to the output voltage in closed loop can be:

$$H ( s ) = \frac{{V}_{o} ( s )}{{V}_{ref} ( s )} = \frac{{τ}_{z} s + 1}{\frac{{s}^{2}}{{ω}_{n}^{2}} + {τ}_{z} s + 1}$$

where:

$${τ}_{z} = {R}_{c} {C}_{c}$$

$${ω}_{n}^{2} = \frac{{g}_{m} {g}_{mc}}{{C}_{c} {C}_{o}}$$

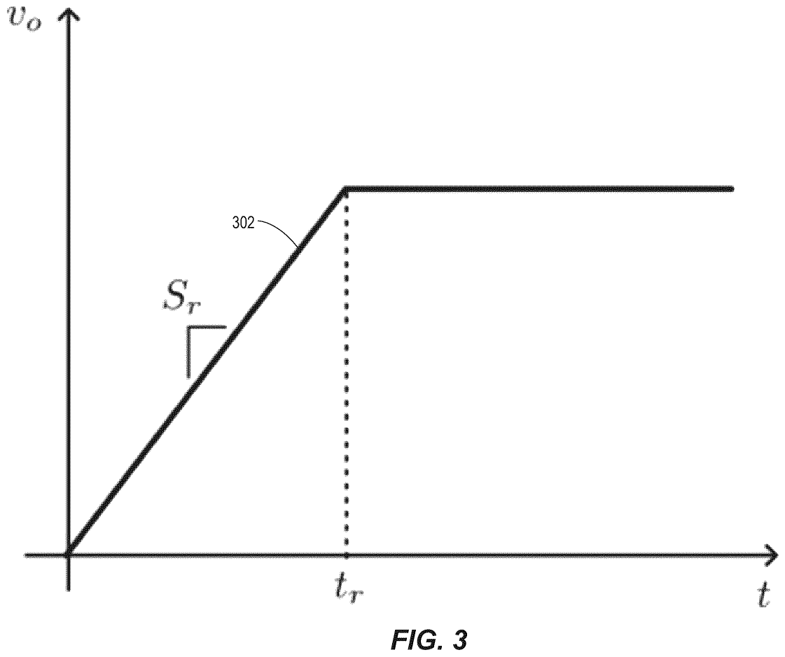

In some embodiments, a desired output voltage can be described in the Laplace domain. FIG. 3 illustrates an exemplary ramp during a DVS starting at zero, having a slope Sr and ending at time tr. The ramp starting at the time origin and at zero voltage is illustrative and can be translated to arbitrary voltage and time coordinates. In various embodiments, the slope of the ramp signal 302 can be positive while in other alternate embodiments the slope can be negative. A desired output voltage to track this ramp can be written as:

$${v}_{o} ( t ) = {S}_{r} t \cdot u ( t ) - {S}_{r} ( t - {t}_{r} ) \cdot u ( t - {t}_{r} )$$

$${V}_{o} ( s ) = \frac{{S}_{r}}{{s}^{2}} - \frac{{S}_{r} {e}^{- {t}_{r} s}}{{s}^{2}}$$

Thus, the reference voltage can be generated as:

$${V}_{r e f} ( s ) = \frac{{V}_{o} ( s )}{H ( s )} = \frac{\frac{{s}^{2}}{{ω}_{n}^{2}} + {τ}_{z} s + 1}{{τ}_{z} s + 1} \cdot \frac{{S}_{r} ( 1 - {e}^{- {t}_{r} s} )}{{s}^{2}}$$

In various embodiments, there may be two ways of implementing this reference voltage. The first is to take an inverse Laplace transform and find the function in the time domain. The second is to take the ramp function and process it with the inverse of the regulator transfer function. In various embodiments, an inverse may not be causal and may be non-implementable. Embodiment of the disclosure enable a solution in a couple of different ways that are described below.

### Time-Domain Reference Voltage

In some embodiments, an inverse Laplace transform of the reference voltage can be taken by separating the exponential term:

$${V}_{r e f} ( s ) = {V}_{r e f 1} ( s ) ( 1 - {e}^{- {t}_{r} s} ) = {V}_{r e f 1} ( s ) - {V}_{r e f 2} ( s )$$

$${V}_{r e f 1} ( s ) = \frac{\frac{{s}^{2}}{{ω}_{n}^{2}} + {τ}_{z} s + 1}{{τ}_{z} s + 1} \cdot \frac{{S}_{r}}{{s}^{2}}$$

where V_{ref2} is a time-shifted version of V_{ref1}.

Partial fraction expansion can be used to solve for V_{ref1}. There is one pole and one double-pole in the expression:

$${V}_{r e f 1} ( s ) = \frac{A}{{τ}_{z} s + 1} + \frac{B}{s} + \frac{C}{{s}^{2}}$$

The values of A, B, and C can be given by:

$$( A + B {τ}_{z} ) {s}^{2} + ( B + C {τ}_{z} ) s + C = {S}_{r} ( \frac{{s}^{2}}{{ω}_{n}^{2}} + {τ}_{z} s + 1 )$$

This results in:

$$A = \frac{{S}_{r}}{{ω}_{n}^{2}}$$

$$B = 0$$

$$C = {S}_{r}$$

Thus:

$${V}_{r e f 1} ( s ) = \frac{\frac{{S}_{r}}{{ω}_{n}^{2}}}{{τ}_{z} s + 1} + \frac{{S}_{r}}{{s}^{2}}$$

and the corresponding time-domain function is:

$${v}_{r e f 1} ( t ) = ( \frac{{S}_{r}}{{τ}_{z} {ω}_{n}^{2}} {e}^{\frac{t}{{τ}_{z}}} + {S}_{r} t ) \cdot u ( t )$$

$$Also ,$$

$${v}_{r e f 2} ( t ) = {v}_{r e f 1} ( t - {t}_{r} ) = ( \frac{{S}_{r}}{{τ}_{z} {ω}_{n}^{2}} {e}^{- \frac{t - {t}_{r}}{{τ}_{z}}} + {S}_{r} ( t - {t}_{r} ) ) \cdot u ( t - {t}_{r} )$$

Putting together the two expressions, the time domain voltage reference function can be obtained:

$${v}_{r e f} ( t ) = {v}_{ref 1} ( t ) - {v}_{r e f 2} ( t ) = \{ \begin{matrix}\frac{{S}_{r}}{{τ}_{z} {ω}_{n}^{2}} {e}^{- \frac{t}{{τ}_{z}}} + {S}_{r} t , & t \leq {t}_{r} \\ \frac{{S}_{r}}{{τ}_{z} {ω}_{n}^{2}} ( 1 - {e}^{\frac{{t}_{r}}{{τ}_{z}}} ) {e}^{- \frac{t}{{τ}_{z}}} + {S}_{r} {t}_{r} , & t > {t}_{r}\end{matrix}$$

Note that the reference voltage is equal to the ramp voltage plus a decaying exponential function with different coefficients during the ramp and after the ramp is completed.

In some embodiments, an inverse Laplace transform of the reference voltage Vref(s) can be taken to obtain a time-domain expression for the reference voltage. The reference voltage Vref(s) can be separated into two terms by factoring out an exponential term. A first term Vref1(s) can represent a component of the reference voltage without time shifting. A second term Vref2(s) can represent a time-shifted version of the first term. The first term Vref1(s) can be arranged to be processed using partial fraction expansion to facilitate inverse Laplace transformation.

In various embodiments, the first term Vref1(s) can be expressed as a sum of partial fractions. The partial fractions can include a term with a pole at a location determined by the zero time constant τz. The partial fractions can include a term with a double pole at the origin. Coefficients of the partial fractions can be determined by equating numerators of the partial fraction expansion to the numerator of the original expression. In some embodiments, a coefficient A can be equal to the slope Sr divided by the product of the zero time constant τz and the natural frequency squared ωn². A coefficient B can be equal to zero. A coefficient C can be equal to the slope Sr.

In certain embodiments, the first term Vref1(s) can be expressed in terms of the coefficients A, B, and C. The first term Vref1(s) can include a term with the coefficient A divided by a factor involving the zero time constant τz. The first term Vref1(s) can include a term with the coefficient C divided by s squared. The corresponding time-domain function vref1(t) can be obtained by taking the inverse Laplace transform of Vref1(s). The time-domain function vref1(t) can include an exponential term with a time constant equal to τz. The time-domain function vref1(t) can include a ramp term proportional to time t.

In some embodiments, the second term vref2(t) can be a time-shifted version of the first term vref1(t). The second term vref2(t) can be obtained by replacing time t with the difference between time t and time tr in the expression for vref1(t). The second term vref2(t) can be multiplied by a unit step function that may be shifted by time tr. In various embodiments, the reference voltage vref(t) can be obtained by subtracting the second term vref2(t) from the first term vref1(t). The reference voltage vref(t) can be arranged to include different expressions for time values less than or equal to tr and for time values greater than tr.

In certain embodiments, for time values less than or equal to tr, the reference voltage vref(t) can be equal to a sum of an exponential term and a ramp term. The exponential term can have an amplitude equal to the slope Sr divided by the product of the zero time constant τz and the natural frequency squared ωn². The exponential term can have a time constant equal to τz. The ramp term can have a slope equal to Sr. For time values greater than tr, the reference voltage vref(t) can be equal to a sum of a modified exponential term and a constant term. The modified exponential term can include a factor that may account for the exponential decay during the ramp period. The constant term can be equal to the product of the slope Sr and the ramp duration tr.

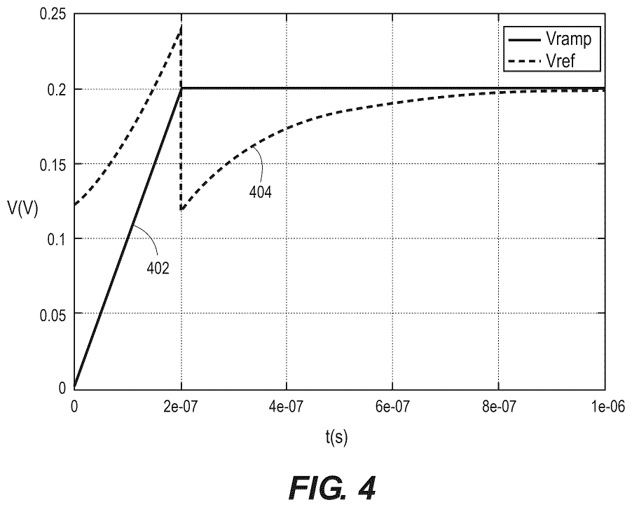

FIG. 4 illustrates a comparison of a reference voltage generated using the above method in response to a ramp signal for a set of typical application values, according to some embodiments. Graph 404 shows the generated reference voltage and graph 402 shows the ramp signal. It shall be understood that the above reference voltage expression can be accomplished by various implementations that are within the scope of this disclosure. In some embodiments, direct digital waveform generation can be used, where a digital circuit may compute the reference value at each sampling time. In various embodiments, the ramp signal can be generated by traditional means, and a correction term can be added where the correction term may be given by the exponential. The correction term can be precomputed, or computed on the fly, or generated using a digital filter. In alternate embodiments, performing a piecewise linear approximation in two or more segments can be used.

In some embodiments, the reference voltage expression can be accomplished by various implementations. Direct digital waveform generation can be used in certain embodiments. A digital circuit may be arranged to compute the reference value at each sampling time. In various embodiments, the ramp signal can be generated by traditional means. A correction term can be added to the ramp signal. The correction term may be given by the exponential component of the reference voltage expression. The correction term can be precomputed in some embodiments. The correction term can be computed on the fly in other embodiments. The correction term can be generated using a digital filter in certain embodiments.

In some embodiments, a piecewise linear approximation can be used to generate the reference voltage. The piecewise linear approximation can be performed in two or more segments. Breakpoints can be defined at key time instants during the DVS transition. Voltage values at the breakpoints can be calculated based on the exponential reference voltage expression. Linear segments can be constructed between consecutive breakpoints. The piecewise linear approximation can be arranged to reduce computational complexity while maintaining acceptable accuracy.

### Prefiltering the Ramp Signal to Generate the Reference Voltage

As described above, the reference voltage can be generated by filtering the ramp signal with the inverse of the converter transfer function H(s). Given that the inverse of H(s) may not be causal, embodiments of the disclosure generate some modifications to the transfer function H(s). Modifications to the transfer function H(s) can be made to enable practical implementation. In certain embodiments, a high-frequency pole can be added to the inverse transfer function. A prefilter transfer function Hpre1(s) can be arranged to include the inverse of the converter transfer function multiplied by a factor that may introduce the high-frequency pole. The high-frequency pole can be located at a sufficiently high frequency such that the prefilter may generate a reference signal that can be close to an ideal value. In some embodiments, embodiments of the disclosure allow an addition of a high-frequency pole, such the prefilter transfer function H(s) may become:

$${H}_{p r e 1} ( s ) = \frac{\frac{{s}^{2}}{{ω}_{n}^{2}} + {τ}_{z} s + 1}{( {τ}_{z} s + 1 ) ( {τ}_{p} s + 1 )}$$

This can generate a reference signal that is relatively close to a value that can be beneficial to be readily implemented, so long as the pole is located at a sufficiently high frequency.

In various embodiments, the expression for Vref(s) can be modified. Note that the ramp signal can introduce a double-pole at the origin in the expression. One of those poles can be moved to the prefilter, turning it into a causal filter that can readily be implemented, and change the input signal to its own derivative, i.e., instead of a ramp it now becomes a pulse:

$${V}_{r e f} ( s ) = \frac{\frac{{s}^{2}}{{ω}_{n}^{2}} + {τ}_{z} s + 1}{{τ}_{z} s + 1} \cdot \frac{{S}_{r} ( 1 - {e}^{- {t}_{r} s} )}{{s}^{2}} = \frac{\frac{{s}^{2}}{{ω}_{n}^{2}} + {τ}_{z} s + 1}{( {τ}_{z} s + 1 ) s} \cdot \frac{{S}_{r} ( 1 - {e}^{- {t}_{r} s} )}{s}$$

The new prefilter becomes:

$${H}_{p r e 2} ( s ) = \frac{\frac{{s}^{2}}{{ω}_{n}^{2}} + {τ}_{z} s + 1}{( {τ}_{z} s + 1 ) s}$$

and the input signal is the derivative of the ramp signal:

$${V}_{i n} ( s ) = \frac{{S}_{r} ( 1 - {e}^{- {t}_{r} s} )}{s} \qquad ( 1 )$$

$${v}_{i n} ( t ) = {S}_{r} ( u ( t ) - u ( t - {t}_{r} ) ) = \{ \begin{matrix}{S}_{r} , & t \leq {t}_{r} \\ 0 , & t > {t}_{r}\end{matrix} \qquad ( 2 )$$

In various embodiments, the expression for Vref(s) can be modified to enable causal implementation. A ramp signal can introduce a double-pole at the origin in the expression for Vref(s). One of the poles can be moved to the prefilter in some embodiments. The input signal can be changed to a derivative of the ramp signal. The derivative of the ramp signal can be a pulse signal. A new prefilter transfer function Hpre2(s) can be arranged to process the pulse signal. The new prefilter transfer function Hpre2(s) can include the inverse of the converter transfer function divided by s.

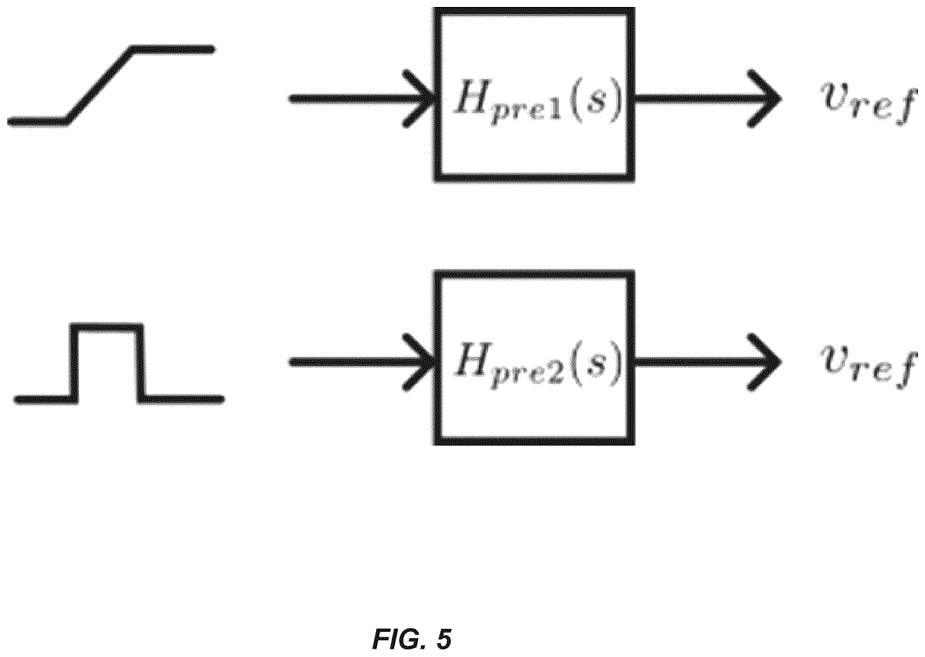

FIG. 5 graphically illustrates options (1) and (2) described above. FIG. 5 graphically illustrates prefiltering options for generating the reference voltage, according to some embodiments. A first option can include applying a prefilter Hpre1(s) to a ramp input signal. The ramp input signal can have a slope equal to Sr. The ramp input signal can start at time zero and end at time tr. The output of the prefilter Hpre1(s) can be the reference voltage vref. A second option can include applying a prefilter Hpre2(s) to a pulse input signal. The pulse input signal can have an amplitude equal to Sr. The pulse input signal can start at time zero and end at time tr. The output of the prefilter Hpre2(s) can be the reference voltage vref.

In some embodiments, the prefilter Hpre1(s) can be designed such that a product of the prefilter transfer function and the converter transfer function H(s) may approximate unity. The prefilter Hpre1(s) can be arranged to compensate for magnitude and phase characteristics of the converter transfer function. In various embodiments, the prefilter Hpre1(s) can be implemented as a digital filter. The digital filter can be an infinite impulse response (IIR) filter in certain embodiments. The digital filter can be a finite impulse response (FIR) filter in other embodiments. The prefilter Hpre1(s) can be arranged to process the ramp signal in real-time to generate the pre-distorted reference voltage.

In certain embodiments, the prefilter Hpre2(s) can be designed to process a pulse input signal. The pulse input signal can be simpler to generate than a ramp signal in some implementations. The prefilter Hpre2(s) can be arranged to integrate the pulse signal while applying compensation for converter dynamics. In various embodiments, the prefilter Hpre2(s) can be implemented as a digital filter. The digital filter can be arranged to have a transfer function that may include an integrator and compensation terms. The prefilter Hpre2(s) can be arranged to generate a reference voltage that may cause the output voltage to follow the desired ramp trajectory.

Improved Converter Response with Pre-Distorted Reference

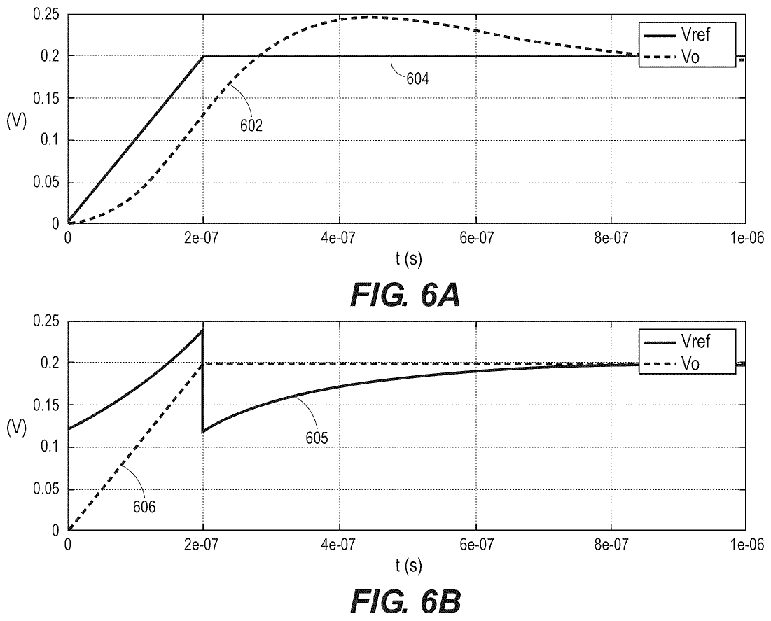

FIGS. 6A and 6B show a comparison of output voltages generated by current approaches and by methods disclosed herein. Graph 602 in FIG. 6A shows an output voltage of the regulator when the reference voltage 604 is the ramp signal, where the output voltage has a substantial variation as compared to the reference voltage 604. Graph 606 in FIG. 6B shows an output voltage of the regulator when the reference voltage 605 is generated according to disclosed methods as described above, where the output voltage is substantially close to a ramp signal. As shown in FIG. 6B, embodiments of the disclosure enable the converter to generate output voltages during transitions that can be substantially improved as compared to current approaches.

### Sampling Effect and Linear Approximation

In some embodiments, the converter can be arranged to generate output voltages during transitions that may be substantially improved as compared to current approaches. The pre-distorted reference voltage can be arranged to cause the converter to produce an output voltage that may closely track the desired ramp trajectory. The pre-distorted reference voltage can be arranged to compensate for delays in the current control loop. The pre-distorted reference voltage can be arranged to compensate for resonances introduced by the output impedance and the compensator transfer function. The pre-distorted reference voltage can be arranged to prevent undershoot during transitions to lower voltages. The pre-distorted reference voltage can be arranged to prevent overshoot during transitions to higher voltages.

In some embodiments, a more precise transfer function describing the inner current loop for a constant on-time (COT) modulation with four phases can be considered. The transfer function can include terms that may account for sampling and hold effects. The transfer function can include exponential terms that may represent delays introduced by the switching period T and the on-time Ton. The transfer function can include terms that may represent ramp slopes Se and Sf. The ramp slope Se can be an external ramp slope. The ramp slope Sf can be a sensed inductor current fall slope. The transfer function with 4 phases can be written as:

$${H}_{i} ( s ) = \frac{1}{T} \cdot \frac{1 - {e}^{- s {T}_{o n}}}{{S}_{e} ( 1 - {e}^{- \frac{s T}{4}} ) + {S}_{f}} \cdot \frac{{V}_{i}}{L \cdot s}$$

where T is the switching period, Ton is the ON-time, Se is the ramp slope, and Sf is the sensed inductor current fall slope. Assuming Se is approximately equal to Sf, and approximating the exponentials with first-order Taylor series, it can be written:

$${H}_{i} ( s ) ∼ \frac{1}{T} \cdot \frac{s {T}_{on}}{1 + \frac{sT}{4}} \cdot \frac{{V}_{i}}{{S}_{f} \cdot L \cdot s} = {g}_{m c} \cdot \frac{1}{1 + \frac{s T}{4}}$$

where Sf has been given a value equal to 1/gmc*Vo/L.

In this approximation, the current loop gain may introduce a lagging effect due to the sampling and hold effect, with a delay that is approximately T/4. The inverse of this effect would be non-causal, as it would use anticipation of the succeeding signals. Since the shape of a succeeding signal may be known, its value can be anticipated with certainty.

A value of the voltage reference at time zero can be given by:

$${v}_{r e f} ( 0 ) = \frac{{S}_{r}}{{τ}_{z} {ω}_{n}^{2}}$$

The value of the ramp can be anticipated at time t=T/4 as Sr*T/4, therefore this value can be incorporated at the origin. Further, the reference signal may decrease instantly at time t=tr, dropping a total amount of

$$\frac{{S}_{r}}{{τ}_{z} {ω}_{n}^{2}} .$$

This can be incorporated at time t=tr−T/4. Finally, the reference voltage can be made to converge to the final value Vr=Sr·tr, after a settling time of approximately 3*T.

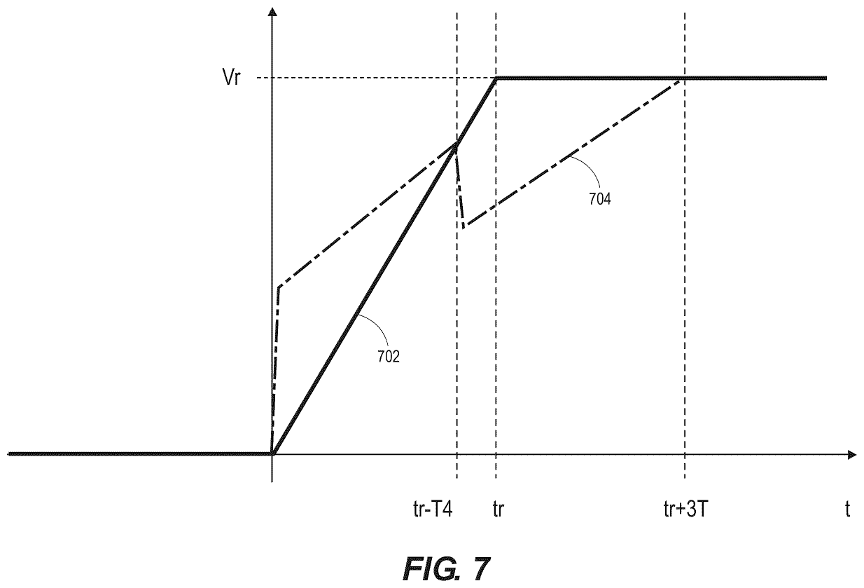

FIG. 7 illustrates a graph showing a linear approximation for the reference voltage, according to some embodiments. Graph 702 shows a ramp signal as a function of time. Graph 704 shows a generated linear approximation for the pre-distorted reference voltage.

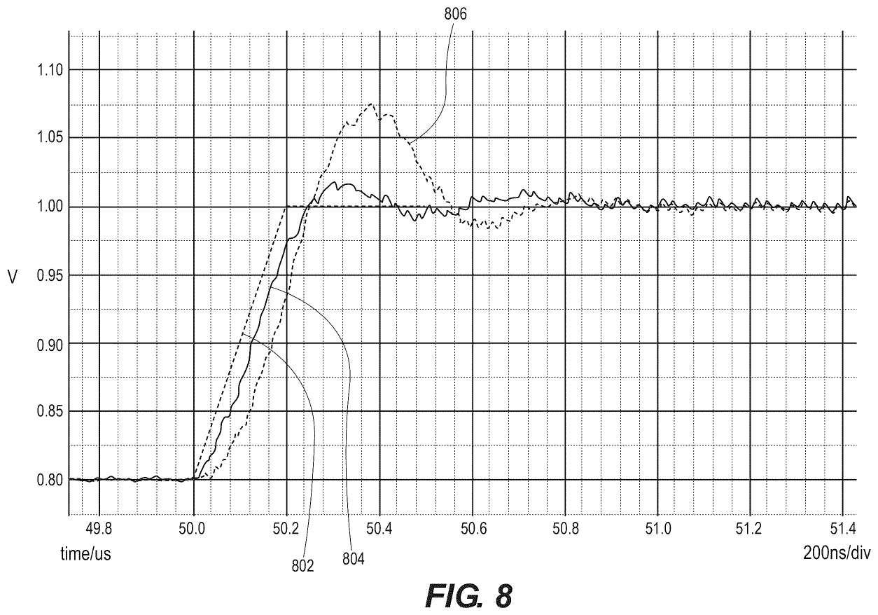

FIG. 8 illustrates the converter response with new pre-distorted reference signal vs ramp signal, according to some embodiments. 804 shows a generated pre-distorted reference voltage graph in response to a ramp signal 802. 806 shows a reference graph without the predistortion.

In certain embodiments, the piecewise linear approximation can be arranged to simplify implementation of the pre-distorted reference voltage generation. The piecewise linear approximation can use multiplication and addition operations. The piecewise linear approximation can be implemented using digital logic circuits in some embodiments. The piecewise linear approximation can be implemented using a microcontroller or digital signal processor in other embodiments. The piecewise linear approximation can be arranged to provide acceptable accuracy while reducing computational complexity compared to computing exponential functions in real-time.

In some embodiments, the converter response to the pre-distorted reference voltage 804 can be substantially improved compared to the response to the simple ramp reference voltage 806. The output voltage in response to the pre-distorted reference voltage 804 can be arranged to follow a trajectory that may be close to the desired ramp. The output voltage can be arranged to reach the final value at approximately the desired time. The output voltage can be arranged to exhibit minimal overshoot. The output voltage can be arranged to settle quickly without significant oscillations. The pre-distorted reference voltage 804 can be arranged to compensate for delays and resonances in the converter such that the output voltage may track the desired ramp trajectory.

In various embodiments, the pre-distorted reference voltage can be generated using any of the methods described herein. The pre-distorted reference voltage can be generated using direct digital waveform generation in some embodiments. The pre-distorted reference voltage can be generated by adding an exponential term to a ramp signal in other embodiments. The exponential term can be precomputed and stored in a lookup table. The exponential term can be computed in real-time using mathematical functions. The exponential term can be generated using a digital filter. The pre-distorted reference voltage can be generated using a piecewise linear approximation in certain embodiments. The pre-distorted reference voltage can be generated by prefiltering a ramp signal or a pulse signal in various embodiments.

### Implementation Variations and Scope

In some embodiments, the reference voltage predistortion circuit 140 can be implemented as a digital signal processor. The digital signal processor can be arranged to execute algorithms for computing the pre-distorted reference voltage. The digital signal processor can include memory for storing parameters such as the zero time constant τz, the natural frequency on, the slope Sr, and the ramp duration tr. The digital signal processor can include arithmetic logic units for performing mathematical operations. The digital signal processor can include input/output interfaces for receiving DVS commands and outputting the pre-distorted reference voltage.

In various embodiments, the reference voltage predistortion circuit 140 can be implemented as an application-specific integrated circuit (ASIC). The ASIC can include dedicated hardware blocks for generating the pre-distorted reference voltage. The ASIC can include lookup tables for storing precomputed values of exponential functions. The ASIC can include digital filters for generating exponential terms or for implementing prefiltering methods. The ASIC can include state machines for controlling the generation of piecewise linear approximations. The ASIC can be arranged to generate the pre-distorted reference voltage with low latency and high precision.

In certain embodiments, the reference voltage predistortion circuit 140 can be implemented as a field-programmable gate array (FPGA). The FPGA can be programmed to implement any of the methods described herein for generating the pre-distorted reference voltage. The FPGA can provide flexibility for adjusting parameters and algorithms. The FPGA can be reprogrammed to accommodate different converter configurations or different DVS specifications. The FPGA can include parallel processing capabilities for computing multiple components of the pre-distorted reference voltage simultaneously.

In some embodiments, the reference voltage predistortion circuit 140 can be implemented using analog circuitry. Analog circuits can be arranged to generate exponential waveforms using resistor-capacitor (RC) networks. Analog circuits can be arranged to sum the exponential waveforms with ramp signals to generate the pre-distorted reference voltage. Analog circuits can provide continuous-time operation without sampling effects. Analog circuits can be suitable for applications where digital processing may introduce unacceptable delays or where power consumption of digital circuits may be a concern.

In various embodiments, the methods described herein can be applied to different types of DC-DC converters. The methods can be applied to buck converters as illustrated in FIG. 1. The methods can be applied to boost converters in other embodiments. The methods can be applied to buck-boost converters in certain embodiments. The methods can be applied to multi-phase converters with any number of phases. The delay compensation factor can be adjusted based on the number of phases. For an n-phase converter, the delay compensation factor can be approximately T/n, where T may be the switching period.

In some embodiments, the methods described herein can be applied to converters using different modulation schemes. The methods can be applied to converters using constant on-time (COT) modulation. The methods can be applied to converters using pulse-width modulation (PWM). The methods can be applied to converters using current-mode control. The methods can be applied to converters using voltage-mode control. The transfer function H(s) can be determined based on the specific modulation scheme and control method used in the converter. The pre-distorted reference voltage can be generated based on the determined transfer function.

In certain embodiments, the parameters used for generating the pre-distorted reference voltage can be determined through characterization of the converter. The zero time constant τz can be measured by analyzing the frequency response of the converter. The natural frequency on can be measured by analyzing transient responses of the converter. The delay compensation factor can be measured by analyzing the phase delay introduced by the inner current loop. The parameters can be stored in non-volatile memory in the reference voltage predistortion circuit 140. The parameters can be updated periodically to account for aging or temperature effects.

In various embodiments, the pre-distorted reference voltage can be generated adaptively based on operating conditions. The parameters used for generating the pre-distorted reference voltage can be adjusted based on the input voltage level. The parameters can be adjusted based on the output voltage level. The parameters can be adjusted based on the load current. The parameters can be adjusted based on the temperature. Adaptive adjustment of parameters can be arranged to maintain optimal performance across a wide range of operating conditions.

In some embodiments, the methods described herein can be combined with other control techniques for improving converter performance. The pre-distorted reference voltage can be combined with adaptive voltage positioning (AVP) techniques. The pre-distorted reference voltage can be combined with load line regulation techniques. The pre-distorted reference voltage can be combined with feed-forward control techniques. The combination of multiple control techniques can be arranged to provide enhanced performance in terms of transient response, steady-state accuracy, and efficiency.

It shall be understood that the methods described herein can be used for various power management applications. The methods can be used in voltage regulators for microprocessors. The methods can be used in voltage regulators for graphics processing units (GPUs). The methods can be used in voltage regulators for system-on-chip (SoC) devices. The methods can be used in voltage regulators for mobile devices. The methods can be used in voltage regulators for data center equipment. The methods can be used in any application where dynamic voltage scaling may be employed to balance performance and power consumption.

In various embodiments, the pre-distorted reference voltage can be generated in response to different types of DVS commands. The DVS command can specify a target voltage level. The DVS command can specify a desired ramp rate. The DVS command can specify a desired transition time. The reference voltage predistortion circuit 140 can be arranged to compute the pre-distorted reference voltage based on the parameters specified in the DVS command. The reference voltage predistortion circuit 140 can be arranged to generate the pre-distorted reference voltage in real-time with minimal latency.

In certain embodiments, the reference voltage predistortion circuit 140 can include safety features to prevent generation of reference voltages that may cause unsafe operation. The reference voltage predistortion circuit 140 can include limits on the maximum rate of change of the reference voltage. The reference voltage predistortion circuit 140 can include limits on the maximum and minimum values of the reference voltage. The reference voltage predistortion circuit 140 can include checks to ensure that the pre-distorted reference voltage may not cause the output voltage to exceed safe operating limits. The safety features can be arranged to protect the load and the converter from damage due to excessive voltage levels or rates of change.

In some embodiments, the converter can include additional circuitry for monitoring the output voltage during DVS transitions. The additional circuitry can include analog-to-digital converters (ADCs) for sampling the output voltage. The additional circuitry can include comparators for detecting when the output voltage may exceed threshold levels. The additional circuitry can provide feedback to the reference voltage predistortion circuit 140. The feedback can be used to adjust the pre-distorted reference voltage in real-time to improve tracking of the desired ramp trajectory. The feedback can be used to update stored parameters for future DVS transitions.

In various embodiments, the converter can include circuitry for detecting the completion of a DVS transition. The circuitry can be arranged to compare the output voltage to the target voltage level. The circuitry can be arranged to determine when the output voltage has settled within a specified tolerance of the target voltage level. The circuitry can generate a signal indicating that the DVS transition has completed. The signal can be provided to the processor or system controller that requested the DVS transition. The processor or system controller can use the signal to coordinate frequency scaling or other actions that may depend on the completion of the voltage transition.

In certain embodiments, the methods described herein can be extended to support multiple simultaneous DVS transitions. The reference voltage predistortion circuit 140 can be arranged to generate pre-distorted reference voltages for multiple independent voltage rails. Each voltage rail can have its own set of parameters for generating the pre-distorted reference voltage. The reference voltage predistortion circuit 140 can include multiple processing channels for computing pre-distorted reference voltages in parallel. The multiple processing channels can be arranged to operate independently to support asynchronous DVS transitions on different voltage rails.

In some embodiments, the pre-distorted reference voltage can be generated using a combination of the methods described herein. A first portion of the pre-distorted reference voltage can be generated using an exponential addition method. A second portion of the pre-distorted reference voltage can be generated using a piecewise linear approximation method. The combination of methods can be arranged to provide a balance between accuracy and computational complexity. The combination of methods can be selected based on the characteristics of the DVS transition, such as the magnitude of the voltage change and the desired ramp rate.

In various embodiments, the reference voltage predistortion circuit 140 can include calibration features. The calibration features can be arranged to measure the actual response of the converter to pre-distorted reference voltages. The calibration features can be arranged to compare the measured response to the desired ramp trajectory. The calibration features can be arranged to adjust parameters used for generating the pre-distorted reference voltage to minimize deviations between the measured response and the desired trajectory. The calibration can be performed during manufacturing, during initial system setup, or periodically during operation.

In certain embodiments, the reference voltage predistortion circuit 140 can include diagnostic features. The diagnostic features can be arranged to monitor the quality of DVS transitions. The diagnostic features can be arranged to measure metrics such as overshoot, undershoot, settling time, and tracking error. The diagnostic features can be arranged to log the measured metrics for analysis. The diagnostic features can be arranged to generate alerts when measured metrics may exceed acceptable thresholds. The diagnostic features can be used to detect degradation of converter performance over time or to identify operating conditions that may use adjustment of predistortion parameters.

Although circuits and methods are described and illustrated herein with respect to several particular configurations of DC-DC buck converter circuits, embodiments of the disclosure are suitable for use in other power converter circuits, such as, but not limited to, boost converter circuits and buck-boost converter circuits. In various embodiments, disclosed methods can be used for a multi-phase converter having any number of phases. In some embodiments, disclosed methods can be used for converters employing different modulation schemes such as PWM or current-mode control. Other implementation circuits for generating pre-distorted reference voltages are within the scope of this disclosure.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

In the preceding detailed description, numerous specific details have been set forth to provide a thorough understanding of claimed subject matter. However, it will be understood by those skilled in the art that claimed subject matter may be practiced without these specific details. In other instances, methods and DC-DC converters that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

In some embodiments, combination of the circuits and methods disclosed herein can be utilized to provide DC-DC converters having reference voltage predistortion for optimal dynamic voltage scaling (DVS) response. Although circuits and methods are described and illustrated herein with respect to several particular configuration of DC-DC buck converter circuits, embodiments of the disclosure are suitable for providing accurate output voltage generation during dynamic voltage scaling in other power converter circuits, such as, but not limited to, boost and buck-boost circuits. In various embodiments, circuits and techniques disclosed herein can be used for a boost converter. In various embodiments, circuits and techniques disclosed herein can be used for a buck-boost converter. The techniques described herein may be applied to various types of power converters, including but not limited to multi-phase buck converters, boost converters, and other switched-mode power supply topologies.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and DC-DC converters that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A DC-DC converter comprising:
a first switch coupled to a second switch at a switch node, the first switch coupled to an input terminal and the second switch coupled to ground, and the switch node coupled to an output terminal;
a control circuit coupled to the first and second switches, and arranged to generate an output voltage at the output terminal via the first and second switches, the control circuit comprising a reference voltage generation circuit arranged to generate a pre-distorted reference signal in response to a command specifying a target output voltage and a desired ramp, the desired ramp having a desired ramp rate and a desired transition time; and
wherein the pre-distorted reference signal comprises a compensation component that compensates for dynamic response characteristics of the DC-DC converter such that the control circuit regulates the output voltage to track the target output voltage and desired ramp rate.

2. The DC-DC converter of claim 1, wherein the pre-distorted reference signal is calculated based on the desired ramp rate plus an exponential decay term.

3. The DC-DC converter of claim 2, wherein the exponential decay term comprises an amplitude factor and a time constant, wherein the time constant is based on a closed-loop transfer function of the DC-DC converter.

4. The DC-DC converter of claim 3, wherein the closed-loop transfer function is based on an inner current loop transfer function, a compensator transfer function, and an output impedance transfer function of the DC-DC converter.

5. The DC-DC converter of claim 1, wherein the reference voltage generation circuit comprises a lookup table having precomputed exponential values, and wherein the reference voltage generation circuit is arranged to retrieve exponential values from the lookup table during generation of the pre-distorted reference signal.

6. The DC-DC converter of claim 2, wherein the reference voltage generation circuit comprises a digital filter arranged to generate the exponential decay term by filtering the desired ramp rate.

7. The DC-DC converter of claim 1, wherein the reference voltage generation circuit is arranged to generate the pre-distorted reference signal as a piecewise linear approximation comprising a plurality of linear segments with different slopes.

8. The DC-DC converter of claim 7, wherein the plurality of linear segments comprises:
a first segment having a first slope during a first time interval;
a second segment having a second slope during a second time interval following the first time interval; and
a third segment having a third slope during a third time interval following the second time interval, wherein the first slope is greater than a slope of the desired ramp rate.

9. The DC-DC converter of claim 8, wherein the first time interval extends from a start time to a time equal to a transition end time minus one-quarter of a switching period of the DC-DC converter.

10. The DC-DC converter of claim 1, wherein the reference voltage generation circuit comprises a prefilter arranged to filter an input signal to generate the pre-distorted reference signal, wherein the prefilter has a transfer function that is an inverse of a closed-loop transfer function of the DC-DC converter.

11. The DC-DC converter of claim 10, wherein the input signal comprises a ramp signal having a slope equal to the desired ramp rate.

12. The DC-DC converter of claim 10, wherein the input signal comprises a pulse signal having a constant amplitude during a transition period.

13. The DC-DC converter of claim 1, wherein the reference voltage generation circuit is arranged to terminate the pre-distorted reference signal at a time earlier than a nominal end time of the desired ramp by an amount equal to a phase-dependent delay of the DC-DC converter.

14. The DC-DC converter of claim 13, wherein the DC-DC converter comprises a multi-phase converter having N phases, and wherein the phase-dependent delay is equal to a switching period divided by N.

15. The DC-DC converter of claim 1, wherein the reference voltage generation circuit comprises:
a digital signal processor arranged to compute the pre-distorted reference signal based on stored system parameters; and
a digital-to-analog converter coupled to the digital signal processor and arranged to convert the pre-distorted reference signal to an analog voltage signal provided to the control circuit.

16. The DC-DC converter of claim 15, wherein the stored system parameters comprise at least one of: an inner current loop transfer function parameter, a compensator transfer function parameter, an output impedance transfer function parameter, a switching period, an on-time duration, a number of phases, an input voltage, and an inductance value.

17. The DC-DC converter of claim 1, wherein the control circuit comprises a comparator arranged to compare the output voltage of the DC-DC converter with the pre-distorted reference signal to generate an error signal; and a compensator arranged to process the error signal to generate a control signal for controlling switching of the DC-DC converter.

18. The DC-DC converter of claim 17, wherein the reference voltage generation circuit is arranged to adapt parameters of the pre-distorted reference voltage signal based on measured performance of voltage transitions.

19. A method of operating a DC-DC converter, the method comprising:
providing a first switch coupled to a second switch at a switch node, the first switch coupled to an input terminal and the second switch coupled to ground, and the switch node coupled to an output terminal;
receiving a command specifying a target output voltage and a desired ramp, the desired ramp having a desired ramp rate and a desired transition time;
generating a pre-distorted reference signal in response to the command, wherein the pre-distorted reference signal comprises a compensation component that compensates for dynamic response characteristics of the DC-DC converter; and
regulating an output voltage at the output terminal via the first and second switches based on the pre-distorted reference signal such that the output voltage tracks the target output voltage and desired ramp rate.

20. A circuit comprising:
a first switch coupled to a second switch at a switch node, the first switch coupled to an input terminal and the second switch coupled to ground, and the switch node coupled to an output terminal;
a control circuit coupled to the first and second switches, and arranged to generate an output voltage at the output terminal via the first and second switches, the control circuit comprising a reference voltage generation circuit arranged to generate a pre-distorted reference signal in response to a command specifying a target output voltage and a desired ramp, the desired ramp having a desired ramp rate and a desired transition time; and
wherein the pre-distorted reference signal is calculated based on the desired ramp rate plus an exponential decay term, the exponential decay term comprising an amplitude factor and a time constant, such that the control circuit regulates the output voltage to track the target output voltage and desired ramp rate.
